(19) United States
(12) Patent Application Publication
(10) Pub. No.: US 2010/0100806 A1
(43) Pub. Date: Apr. 22, 2010

(54) METHODS AND APPARATUS FOR THE IMMEDIATE PRODUCTION OF WEB SITES AND PRINT COLLATERALS

(76) Inventor: Aboje Ameh, Schaumburg, IL (US)

Correspondence Address: K&L Gates LLP, P.O. Box 1135, CHICAGO, IL, 60690, US

(21) Appl. No.: 12/253,673

(22) Filed: Oct. 17, 2008

(51) Int. Cl. G06F 17/00

(52) U.S. Cl. 715/234

(57) ABSTRACT

A system for the immediate production of web sites and print collaterals is provided. A server interacts with a user via a client device to gather data about the user's business, such as an associated industry sector. The server then uses this information to prompt the user for additional information and retrieve business graphics relevant to this business. After the user selects a graphics style, the server generates a plurality of business cards and other collateral print materials using the selected business graphics and styles. In addition, the server automatically produces a custom web site using the selected business graphics and styles. The web site may include a plurality of different completed pages including text that is synthesized from text entered by the user (e.g., in to a form) and automatically selected text (e.g., from a database based on industry sector).

### TECHNICAL FIELD

The present application relates in general to web site and print collateral production and more specifically to methods and apparatus for the immediate production of web sites and print collaterals by synthesizing user provided data with automatically selected text and other media.

### BACKGROUND

For small business start-ups, creating a web site and the related task of defining and communicating the visual aspects of their ‘brand’ comprises a number of time and labor intensive pieces sometimes variously sourced. For example, where a logo is desired, a graphic designer iterating through options develops a logo; a web designer/developer then incorporates the logo graphic into a custom-designed web page scripted in Hypertext Markup Language (HTML) and related dynamic languages such as JavaScript or customizes a pre-existing HTML template. In another scenario, the business owner selects from a wide range of design templates, customizing the templates typically using a set of WYSIWYG software tools. In either scenario, the business owner and/or his agent has the additional responsibility of producing copy for the web site. In addition, the production of business collaterals such as cards and stationery is usually a separate undertaking.

### SUMMARY

The present disclosure provides methods and apparatus for the immediate production of web sites and print collaterals by synthesizing user provided data with automatically selected text and other media. The system and process disclosed herein provides for the immediate production of a set of business elements such as a logo, business cards and a web site all from the same underlying small business data. The business owner provides information according to a pre-defined structure by filling-out form fields. Based on user input, the system provides a range of possible identifying visuals for the business prompting the business owner for a selection. Upon receiving the user inputs, the system synthesizes business visuals and other elements using user selected graphic element(s) and the provided business information. Upon user approval, the system develops production versions of the business elements such as printable business cards, stationery, and a deployment-ready web site.

### BRIEF DESCRIPTION OF THE FIGURES

FIG. 1 is a high level block diagram of an example communications system.

FIG. 2 is a more detailed block diagram showing one example of a computing device.

FIG. 3 is a flowchart showing one example of a data entry phase for producing web sites and print collaterals from user data.

FIG. 4 is a flowchart showing one example of a design generation phase for producing web sites and print collaterals from user data.

FIG. 5 is a screen shot of an example ‘about the business’ form.

FIG. 6 is a screen shot of an example ‘products and services’ form.

FIG. 7 is a screen shot of an example ‘corporate’ form.

FIG. 8 is a screen shot of an example ‘business graphics selection’ page.

FIG. 9 is a screen shot of an example ‘business card selection’ page.

FIG. 10 is a screen shot of an example ‘print package setup’ page.

FIG. 11 is a screen shot of an example ‘about the business’ web page.

FIG. 12 is a screen shot of an example ‘products’ web page.

FIG. 13 is a screen shot of an example ‘services’ web page.

FIG. 14 is a screen shot of an example ‘corporate’ web page.

FIG. 15 is a screen shot of an example ‘contact’ web page.

### DETAILED DESCRIPTION

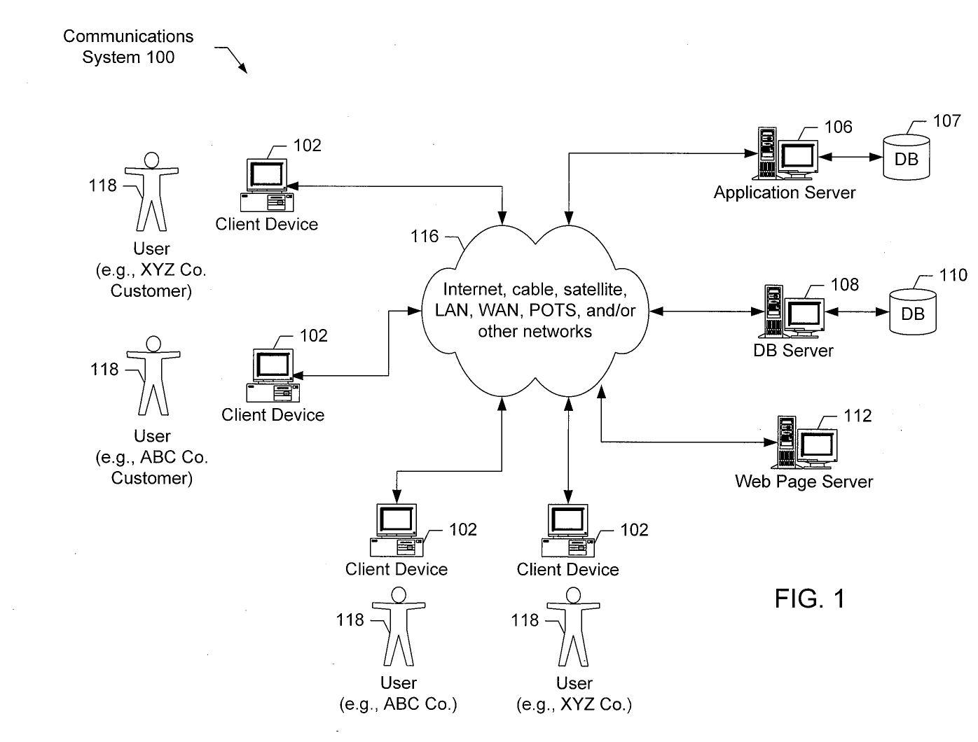

The present system is most readily realized in a network communications system. A high level block diagram of an exemplary network communications system 100 is illustrated in FIG. 1. The illustrated system 100 includes one or more client devices 102, one or more application servers 106, one or more database servers 108 connected to one or more databases 110, and one or more web page servers 112. As described in more detail below, each of these devices may communicate with each other via a connection to one or more communications channels 116. The communications channels 116 may be any suitable communications channels 116 such as the Internet, cable, satellite, local area network, wide area networks, telephone networks, etc. It will be appreciated that any of the devices described herein may be directly connected to each other and/or connected over one or more networks.

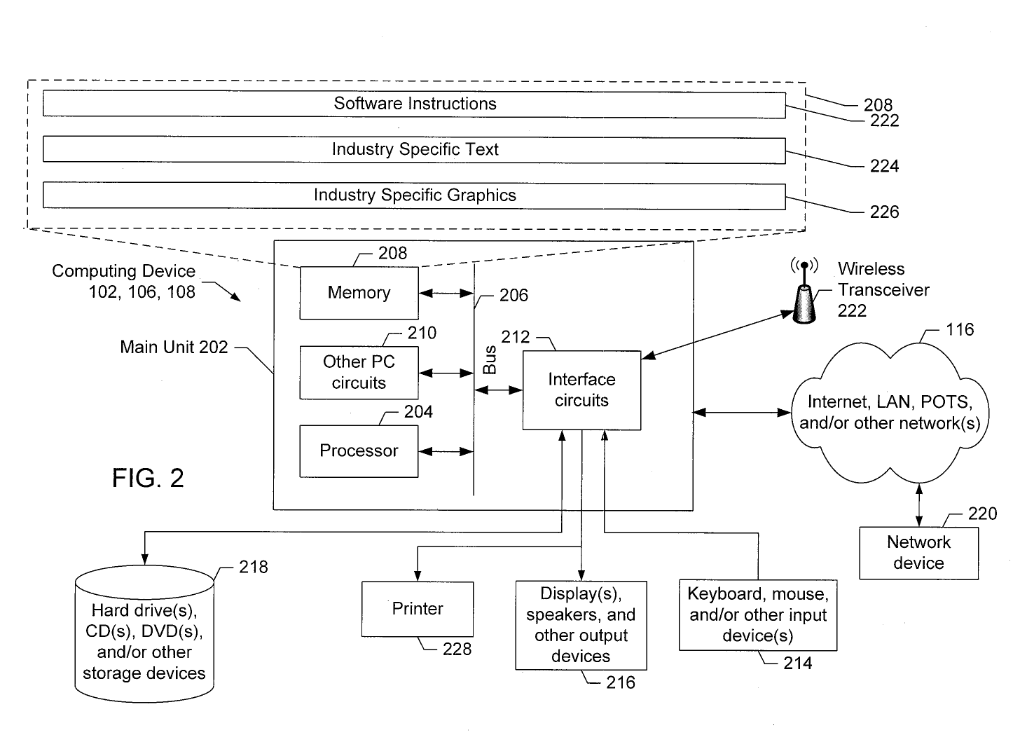

A detailed block diagram of an example computing device 102, 106, 108, 112 is illustrated in FIG. 2. Each computing device 102, 106, 108, 112 may include a server, a personal computer (PC), and/or any other suitable computing device. Each computing device 102, 106, 108, 112 preferably includes a main unit 202 which preferably includes one or more processors 204 electrically coupled by an address/data bus 206 to one or more memory devices 208, other computer circuitry 210, and one or more interface circuits 212. The processor 204 may be any suitable microprocessor.

The memory 208 preferably includes volatile memory and non-volatile memory. Preferably, the memory 208 and/or another storage device 218 stores software instructions 222 that interact with the other devices in the system 100 as described herein. These software instructions 222 may be executed by the processor 204 in any suitable manner. The memory 208 and/or another storage device 218 may also store one or more data structures, digital data indicative of documents, files, programs, web pages, etc. retrieved from another computing device 102, 106, 108, 112 and/or loaded via an input device 214.

The example memory device 208 stores software instructions 222, industry specific text 224, industry specific graphics 226, and other data for use by the system 100 as described in detail below. It will be appreciated that many other data fields and records may be stored in the memory device 208 to facilitate implementation of the methods and apparatus disclosed herein. In addition, it will be appreciated that any type of suitable data structure (e.g., a flat file data structure, a relational database, a tree data structure, etc.) may be used to facilitate implementation of the methods and apparatus disclosed herein.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more printers 228, displays, speakers, and/or other output devices 216 may also be connected to the main unit 202 via the interface circuit 212. The display may be a cathode ray tube (CRTs), liquid crystal displays (LCDs), or any other type of display. The display generates visual displays of data generated during operation of the computing device 102, 106, 108, 112. For example, the display may be used to display screen files received from the application server 106. The visual displays may include prompts for human input, run time statistics, calculated values, data, etc. The printer 228 may be any suitable type of printer such as a ink jet printer, a laser printer, etc. The printer 228 may also be a specialized printer such as business card printer, an envelope printer, a letter head printer, a check printer, a sticker printer, etc.

One or more storage devices 218 may also be connected to the main unit 202 via the interface circuit 212. For example, a hard drive, CD drive, DVD drive, flash memory drive, and/or other storage devices may be connected to the main unit 202. The storage devices 218 may store any type of data used by the computing device 102, 106, 108, 112.

Each computing device 102, 106, 108, 112 may also exchange data with other computing devices 102, 106, 108 and/or other network devices 220 via a connection to the communication channel(s) 116. The communication channel(s) 116 may be any type of network connection, such as an Ethernet connection, WiFi, WiMax, digital subscriber line (DSL), telephone line, coaxial cable, etc. Users 118 of the system 100 may be required to register with the application server 106. In such an instance, each user 118 may choose a user identifier (e.g., e-mail address) and a password which may be required for the activation of services. The user identifier and password may be passed across the communication channel(s) 116 using encryption built into the user's browser, software application, or computing device 102, 106, 108, 112. Alternatively, the user identifier and/or password may be assigned by the application server 106.

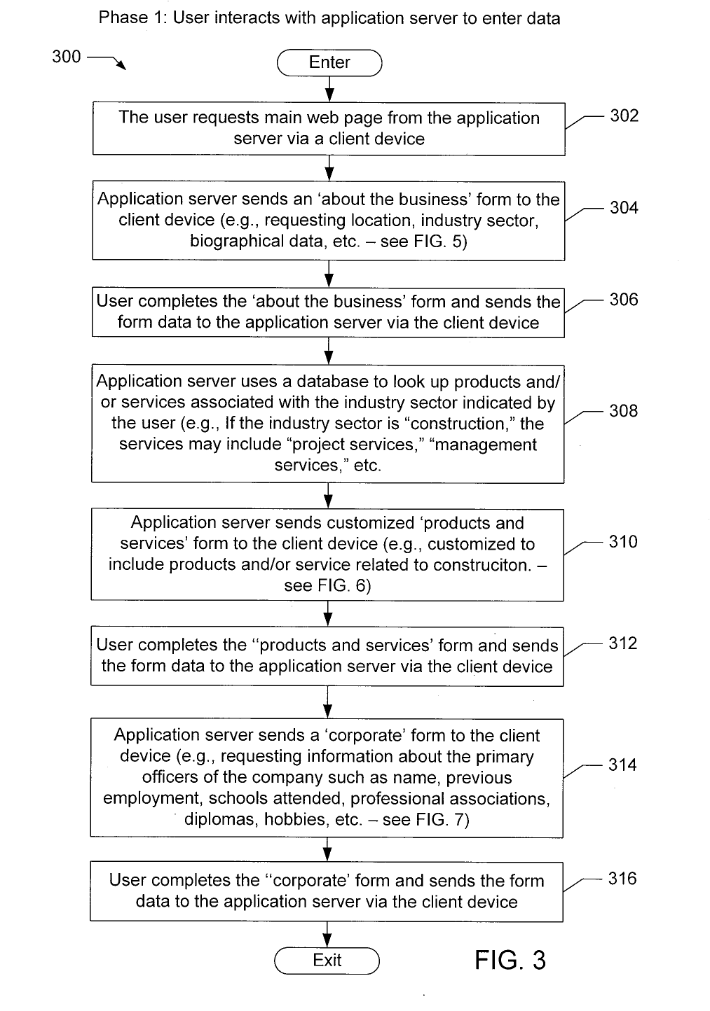

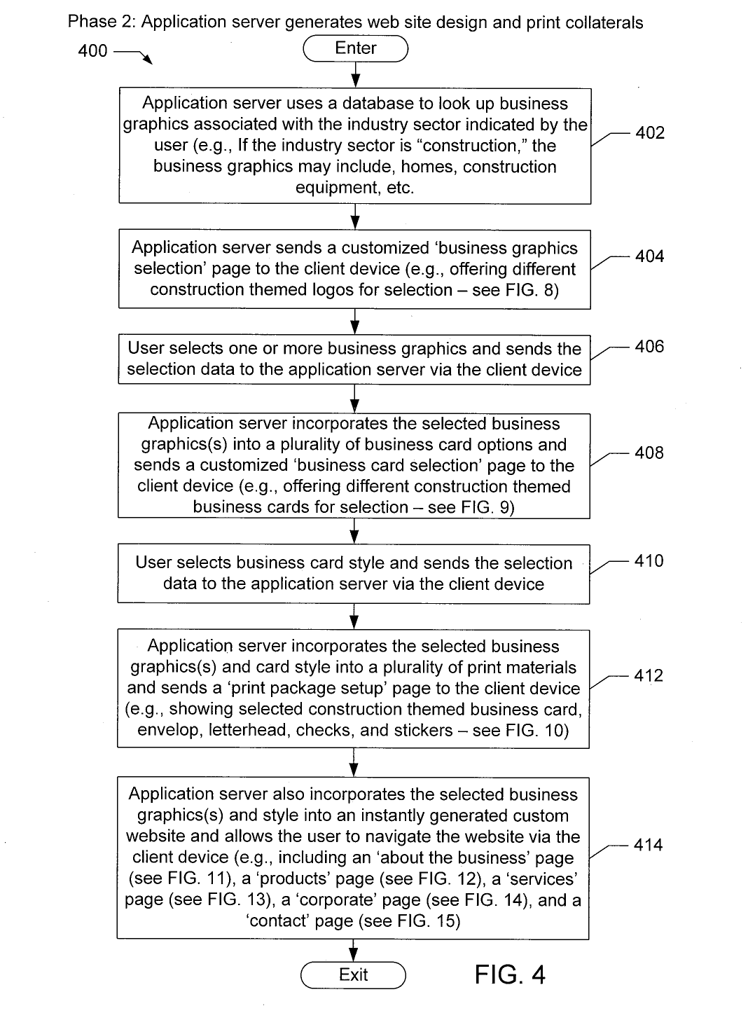

A flowchart of an example process 300, 400 for producing web sites and print collaterals from user data is presented in FIG. 3 and FIG. 4. Preferably, the process 300, 400 is embodied in one or more software programs which are stored in one or more memories and executed by one or more processors. Although the process 300, 400 is described with reference to the flowchart illustrated in FIG. 3, it will be appreciated that many other methods of performing the acts associated with process 300, 400 may be used. For example, the order of many of the steps may be changed, some of the steps described may be optional, and additional steps may be included.

In general, the process 300, 400 causes an application server 106 to interact with a user 118 via a client device 102 to gather data about the user's business such as the location of the business and the industry sector associated with the business. The application server 106 then uses this information to prompt the user 118 with products and/or services typical of that type of business. In addition, the application server 106 gathers information about primary officers of the business such as their name, previous employment, schools attended, professional associations, diplomas, hobbies, etc. The application server 106 then uses this information to retrieve business graphics relevant to this business. After the user 118 selects the business graphics they prefer, the application server 106 automatically generates a plurality of business cards in different styles and presents them to the user 118. In response to a business card selection (or other style selection), the application server 106 automatically produces a plurality of different collateral print materials (e.g., business cards, envelops, letterhead, checks, stickers, etc) using the selected business graphics and styles. In addition, the application server 106 automatically produces a custom web site using the selected business graphics and styles. The web site may include a plurality of different pages such as an ‘about the business’ page, a ‘products’ page, a ‘services’ page, a ‘corporate’ page, and a ‘contact’ page. Preferably, each of these pages is a completed web page including text that is synthesized from text entered by the user (e.g., in to a form) and automatically selected text (e.g., looked up in a database based on industry sector).

More specifically, the example process 300 is a data entry phase for producing web sites and print collaterals from user data. The application server 106 begins the example process 300 when a user 118 requests a web page from the application server 106 via a client device 102 (block 302). For example, the application server 106 may receive a standard hypertext transport protocol request (HTTP) for the home page of a service implementing the system described herein.

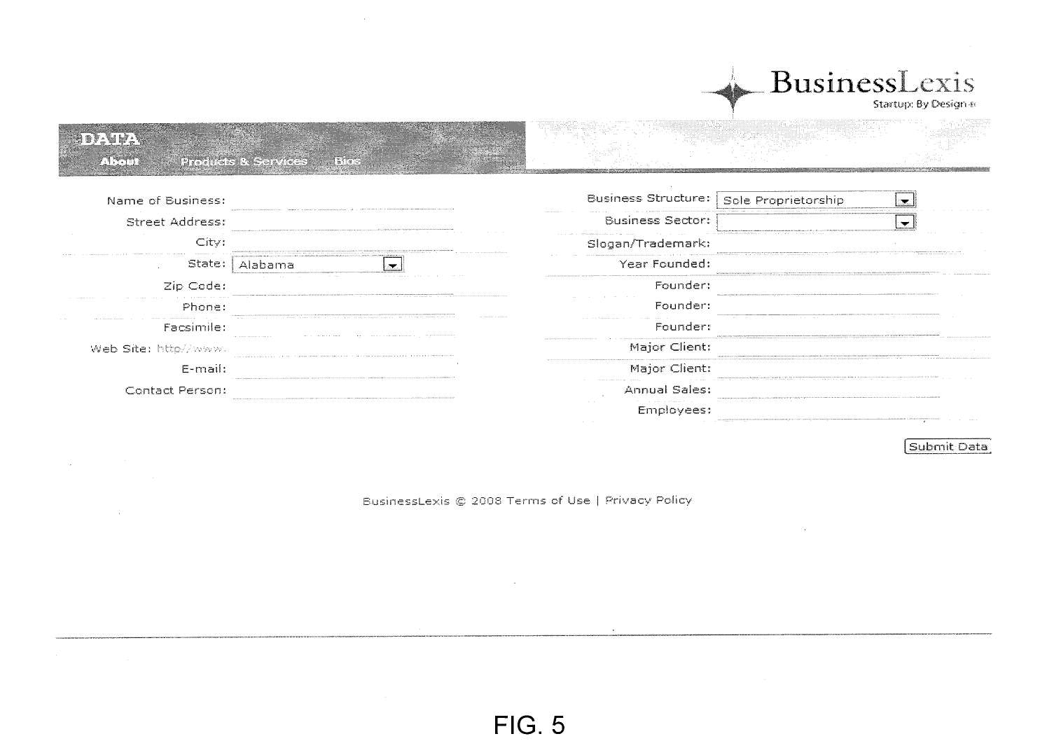

In response, the application server 106 may send an ‘about the business’ form to the client device 102 (block 304). For example, the ‘about the business’ form may request a location of the business (e.g., mail address), an industry sector associated with the business (e.g., construction), and other data associated with the business, etc. Preferably, the industry sector associated with the business is selected from a standardized set of industry sectors. For example, the industry sector may be selected from the North American Industry Classification (NAIC) list of sectors. A screen shot of an example ‘about the business’ form is illustrated in FIG. 5. The user 118 then completes the ‘about the business’ form and sends the form data to the application server 106 via the client device 102 (block 306).

Next, the application server 106 uses a database 107, 110 to look up products and/or services associated with the industry sector indicated by the user 118 (block 308). For example, if the industry sector is “construction,” the services may include “project services,” “management services,” etc. The database 107, 110 may be part of the application server 106, directly connected to the application server 106, and/or connected to the application server 106 via a network 116 and/or a database server 108.

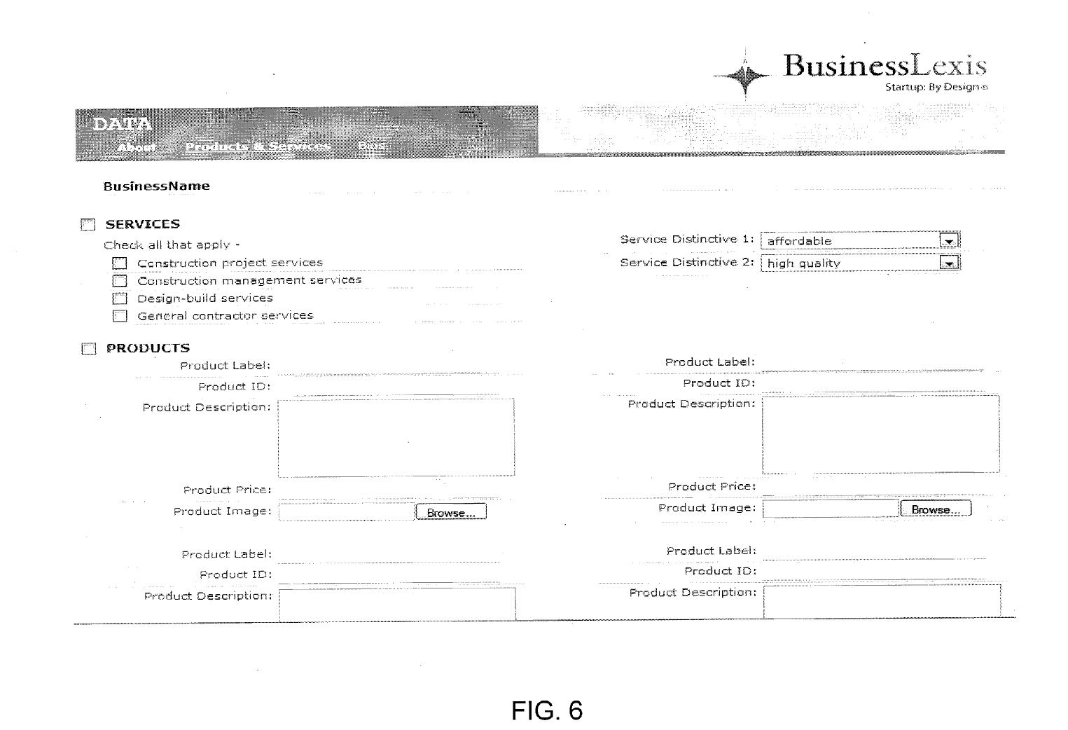

The application server 106 then sends a customized ‘products and services’ form to the client device 102 based on the database lookup (block 310). For example, the ‘products and services’ form may be customized to include products and/or service related to the construction industry. A screen shot of an example ‘products and services’ form is illustrated in FIG. 6. The user 118 then completes the “products and services’ form and sends the form data to the application server 106 via the client device 102 (block 312).

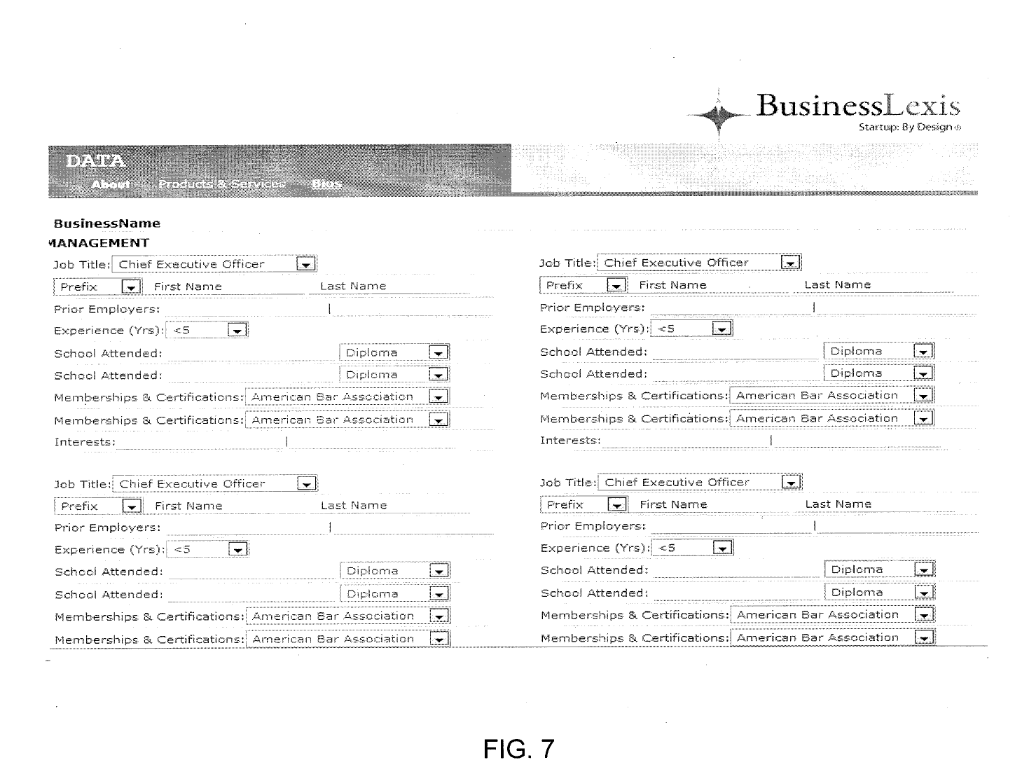

In this example, once the user 118 has completed the ‘products and services’ form, the application server 106 sends a ‘corporate’ form to the client device 102 (block 314). For example, the ‘corporate’ form may request information about the primary officers of the company such as their names, previous employment, schools attended, professional associations, diplomas, hobbies, etc. A screen shot of an example ‘corporate’ form is illustrated in FIG. 7. The user 118 then completes the ‘corporate’ form and sends the form data to the application server 106 via the client device 102 (block 316).

Turing to FIG. 4, the example process 400 embodies a design generation phase for producing web sites and print collaterals from user data. The application server 106 begins the example process 400 by using a database 107, 110 to look up business graphics associated with the industry sector indicated by the user 118 (block 402). For example, if the industry sector is “construction,” the business graphics may include homes, construction equipment, etc.

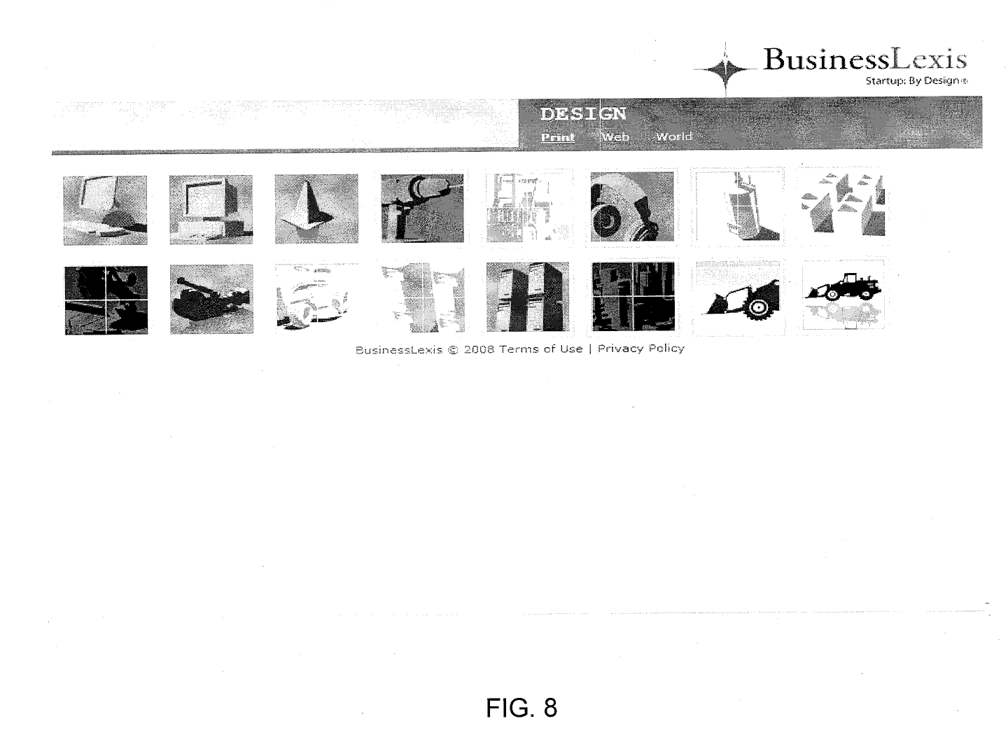

Once the application server 106 looks up business graphics associated with the industry sector indicated by the user 118, the application server 106 sends a customized ‘business graphics selection’ page to the client device 102 (block 404). For example, the customized ‘business graphics selection’ page may offer different construction themed logos for selection by the user 118. A screen shot of an example ‘business graphics selection’ page is illustrated in FIG. 8. The user 118 then selects one or more business graphics and sends the selection data to the application server 106 via the client device 102 (block 406).

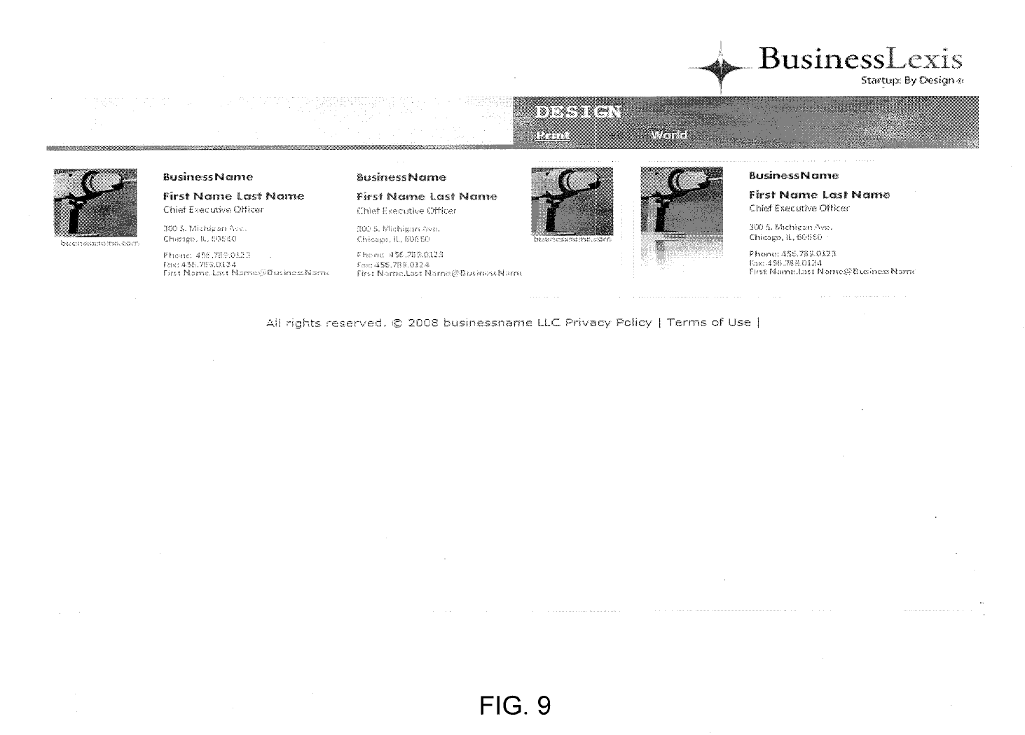

Next, the application server 106 incorporates the selected business graphics(s) into a plurality of business card options and sends a customized ‘business card selection’ page to the client device 102 (block 408). For example, the ‘business card selection’ page may offer different construction themed business cards for selection by the user 118. A screen shot of an example ‘business card selection’ page is illustrated in FIG. 9. The user 118 then selects a business card style and sends the selection data to the application server via the client device (block 410).

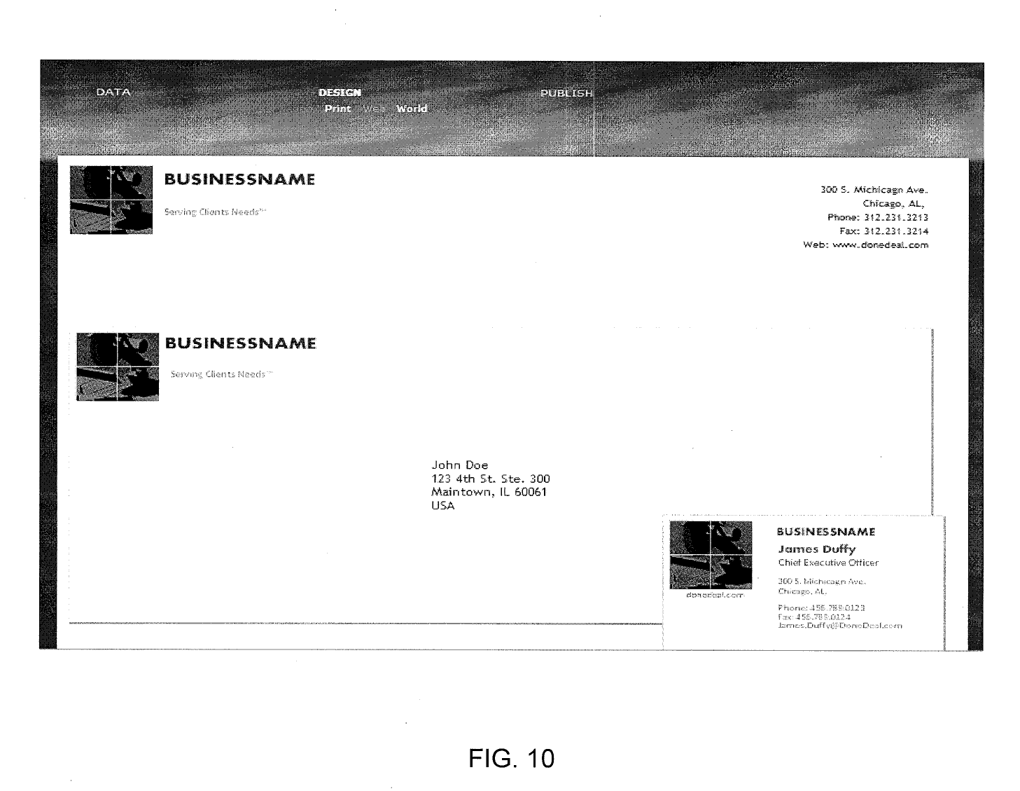

In response to the user 118 selecting a business card style, the application server 106 incorporates the selected business graphics(s) and card style into a plurality of print materials and sends a ‘print package setup’ page to the client device (block 412). For example, the ‘print package setup’ page may show selected construction themed business cards, envelops, letterhead, checks, and stickers. A screen shot of an example ‘print package setup’ page is illustrated in FIG. 10.

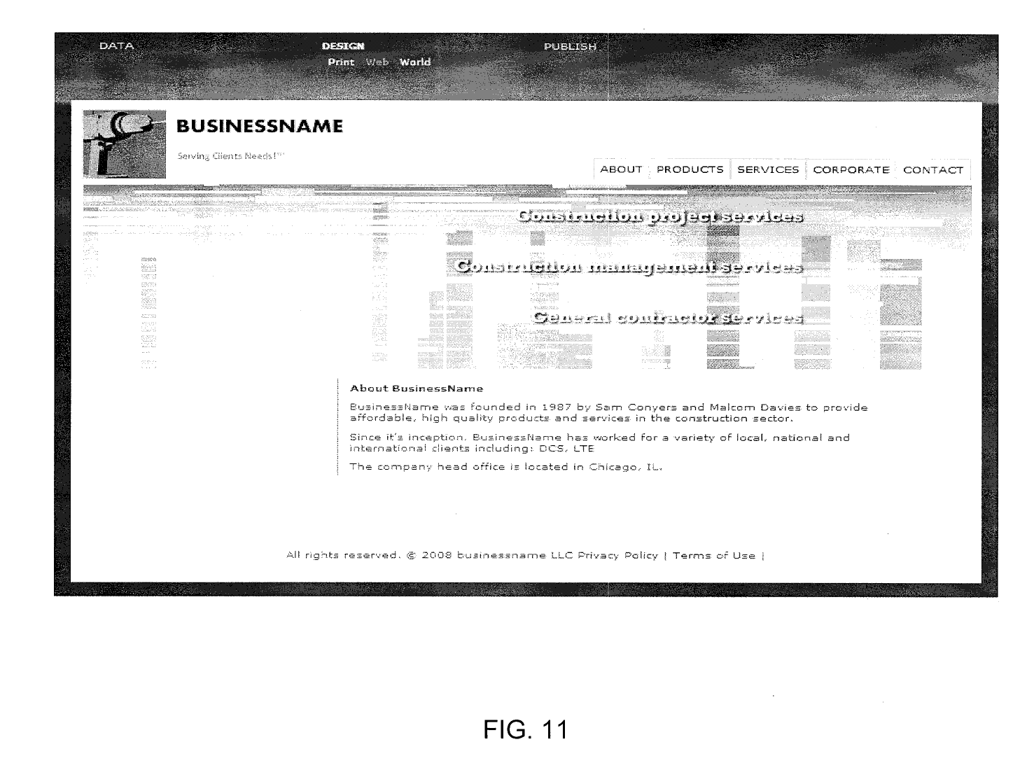

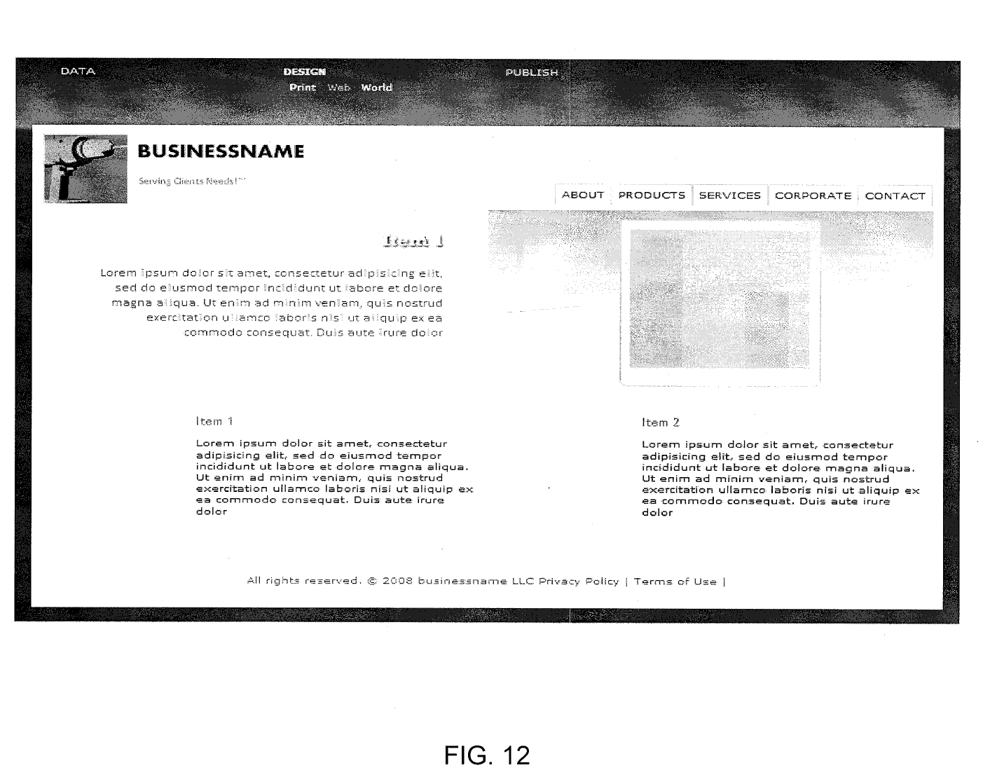

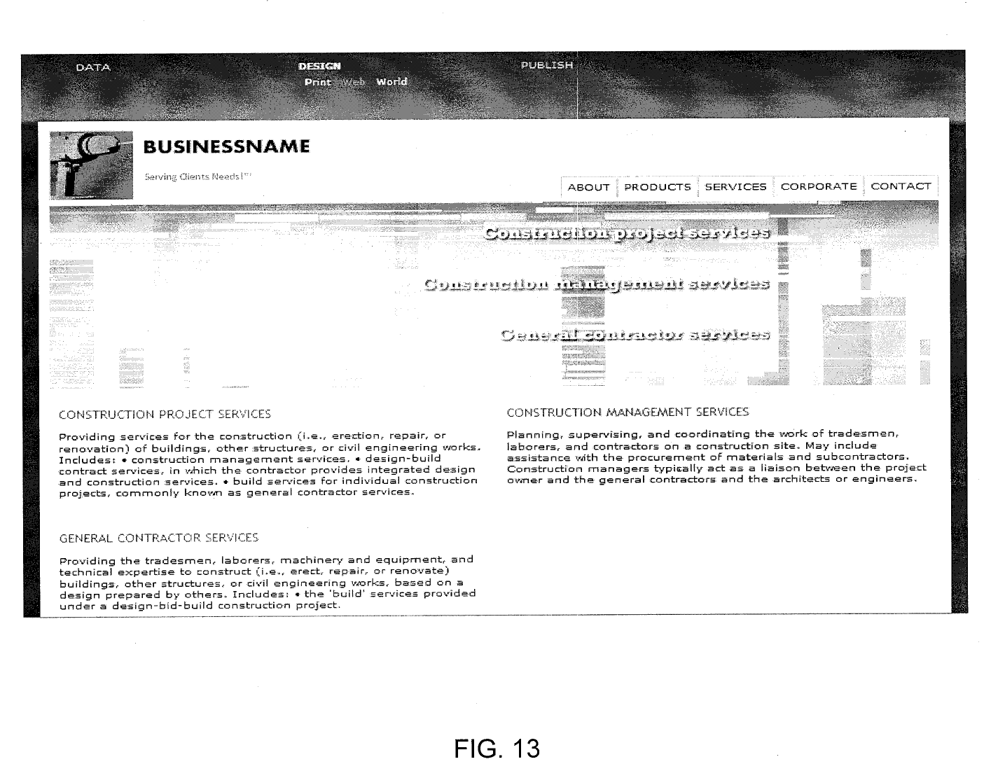

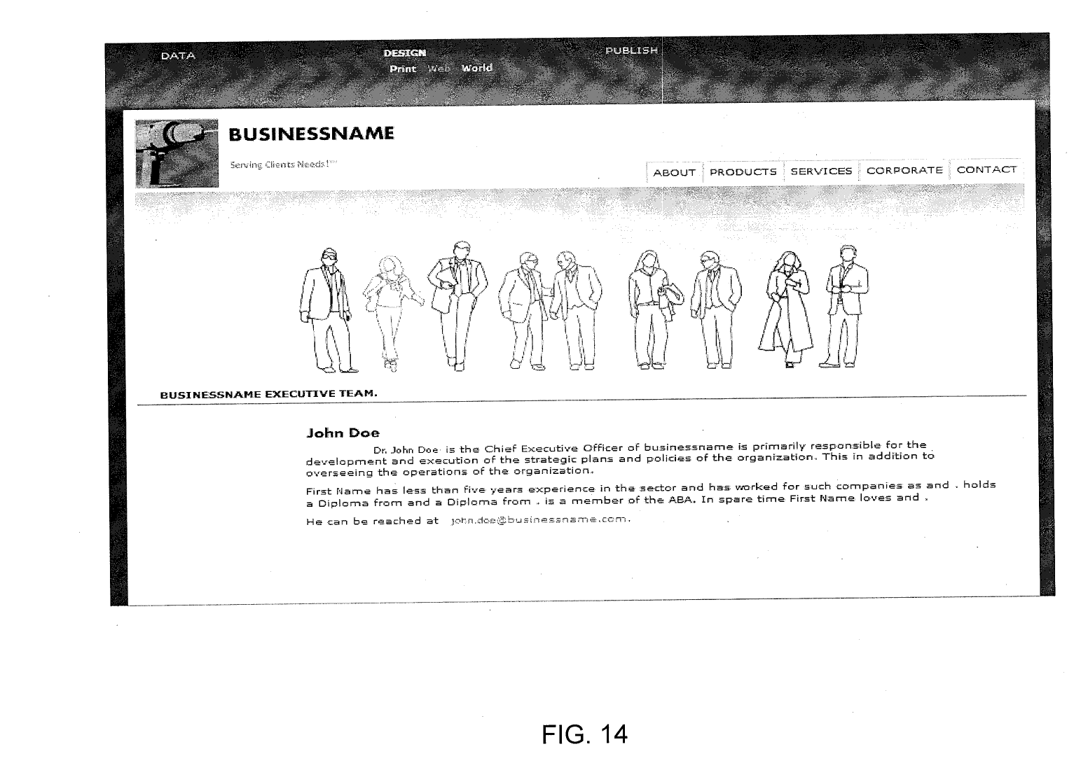

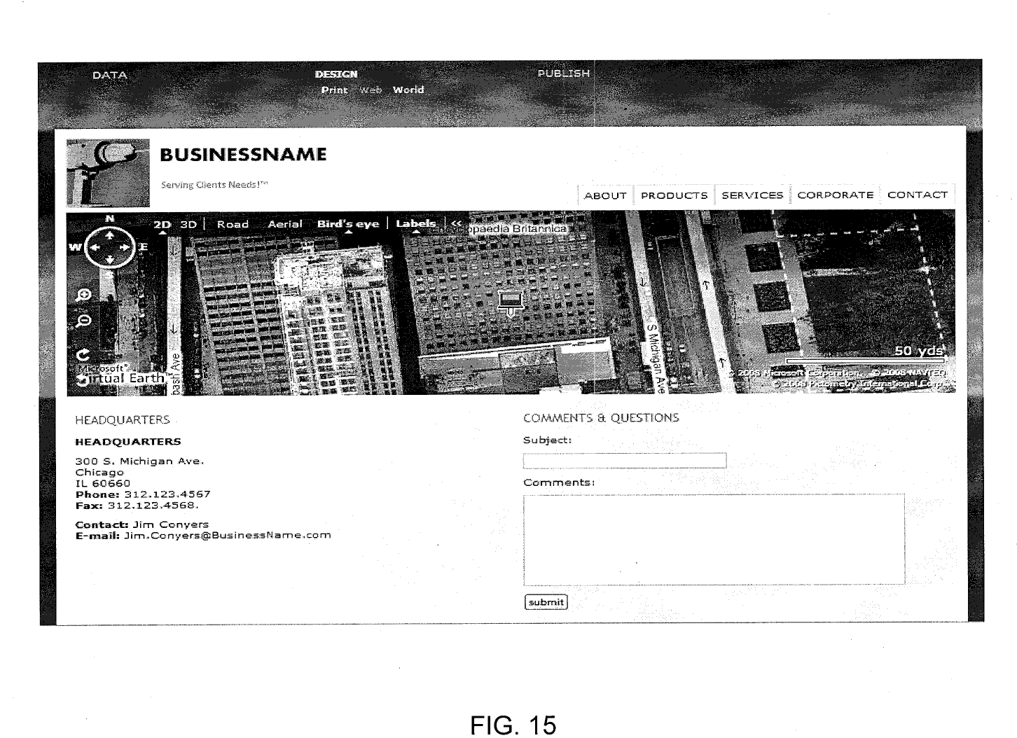

In addition, the application server 106 incorporates the selected business graphics(s) and style into an immediately generated custom web site and allows the user 118 to navigate the web site via the client device 102 (block 414). Preferably the web site includes an ‘about the business’ page (see FIG. 11), a ‘products’ page (see FIG. 12), a ‘services’ page (see FIG. 13), a ‘corporate’ page (see FIG. 14), and a ‘contact’ page (see FIG. 15).

Preferably, each of these pages is a completed web page including text that is synthesized from text entered by the user and automatically selected text. For example, the application server 106 may look up predefined text in a database that introduces a construction company based on the industry sector indicated by the user 118. This predefined text may have one or more place holders for user entered data. For example, the introductory construction company text may be amended with “affordable” and “high quality” because the user 118 choose these distinctives on a ‘products and services’ form (see FIG. 6). This synthesized text is then used to form a completed web page.

In summary, persons of ordinary skill in the art will readily appreciate that methods and apparatus for the production of web sites and print collaterals have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

1. A method of producing a web site and an associated print collateral, the method comprising:
providing a web based application server programmed to interact with a client device to gather business data, the business data including an industry sector;
sending a first prompt for at least one of a product and a service to the client device, the first prompt being based on the industry sector;
receiving data indicative of the at least one product and service from the client device;
retrieving a business graphic based on the industry sector;
receiving a business graphic selection;
generating and sending a plurality of different styles to the client device, the plurality of different styles being based on the business graphic selection;
receiving data indicative of a style selection from the client device;
producing a collateral print material based on the data indicative of the industry sector, the graphic selection, and the style selection;
selecting predetermined text based on the industry sector; and
producing a custom web site based on the data indicative of the industry sector, the graphic selection, and the style selection, the custom web site including text that is synthesized from (i) data received from the user and (ii) the predetermined text.

2. The method of claim 1, wherein the business data includes at least one of a name of the business, a geographic location of the business, and contact information of the business.

3. The method of claim 1, wherein the business data includes at least one of a structure of the business, a slogan of the business, a trademark of the business, a founding year of the business, a founder's name of the business, a client of the business, annual sales of the business, and a number of employees of the business.

4. The method of claim 1, further comprising:
sending a second prompt for at least one officer attribute to the client device; and
receiving data indicative of the at least one officer attribute from the client device.

5. The method of claim 4, wherein receiving data indicative of the officer attribute includes receiving data indicative of at least one of a name of a company officer, a previous employment of the company officer, a school attended by the company officer, and a professional association of the company officer, a diploma of the company officer, and a hobby of the company officer.

6. The method of claim 1, wherein receiving data indicative of the at least one service includes receiving data indicative of at least one of a service distinctive.

7. The method of claim 6, wherein the service distinctive includes at least one aspect of affordability, user centricness, geographic accessibility, convenience, timeliness, and quality.

8. The method of claim 1, wherein receiving data indicative of the at least one product includes receiving data indicative of at least one of a product label, a product identifier, a product description, a product price, and a product image.

9. The method of claim 1, wherein generating and sending the plurality of different styles to the client device includes generating and sending a plurality of different business cards styles to the client device.

10. The method of claim 1, wherein producing the collateral print material includes producing data indicative of at least one of a business card, an envelope, a letterhead, a check, and a sticker.

11. The method of claim 1, wherein producing the custom web site includes producing a first web page about a business, at least a second web page about at least one of a product and a service, and a third web page about contact information.

12. An apparatus for producing a web site and an associated print collateral, the apparatus comprising:
a processor; and
a memory device operatively coupled to the processor, the memory device storing a program to cause the processor to:
provide a web based application server programmed to interact with a client device to gather business data, the business data including an industry sector;
send a first prompt for at least one of a product and a service to the client device, the first prompt being based on the industry sector;
receive data indicative of the at least one product and service from the client device;
retrieve a business graphic based on the industry sector;
receive a business graphic selection;
generate and sending a plurality of different styles to the client device, the plurality of different styles being based on the business graphic selection;
receive data indicative of a style selection from the client device;
produce a collateral print material based on the data indicative of the industry sector, the graphic selection, and the style selection;
select predetermined text based on the industry sector; and
produce a custom web site based on the data indicative of the industry sector, the graphic selection, and the style selection, the custom web site including text that is synthesized from (i) data received from the user and (ii) the predetermined text.

13. The apparatus of claim 12, wherein the business data includes at least one of a name of the business, a geographic location of the business, and contact information of the business.

14. The apparatus of claim 12, wherein the business data includes at least one of a structure of the business, a slogan of the business, a trademark of the business, a founding year of the business, a founder's name of the business, a client of the business, annual sales of the business, and a number of employees of the business.

15. The apparatus of claim 12, further comprising:
sending a second prompt for at least one officer attribute to the client device; and
receiving data indicative of the at least one officer attribute from the client device.

16. The apparatus of claim 15, wherein receiving data indicative of the officer attribute includes receiving data indicative of at least one of a name of a company officer, a previous employment of the company officer, a school attended by the company officer, and a professional association of the company officer, a diploma of the company officer, and a hobby of the company officer.

17. The apparatus of claim 12, wherein receiving data indicative of the at least one service includes receiving data indicative of at least one of a service distinctive.

18. The apparatus of claim 17, wherein the service distinctive includes at least one aspect of affordability, user centricness, geographic accessibility, convenience, timeliness, and quality.

19. The apparatus of claim 12, wherein receiving data indicative of the at least one product includes receiving data indicative of at least one of a product label, a product identifier, a product description, a product price, and a product image.

20. The apparatus of claim 12, wherein generating and sending the plurality of different styles to the client device includes generating and sending a plurality of different business cards styles to the client device.

21. The apparatus of claim 12, wherein producing the collateral print material includes producing data indicative of at least one of a business card, an envelope, a letterhead, a check, and a sticker.

22. The apparatus of claim 12, wherein producing the custom web site includes producing a first web page about a business, at least a second web page about at least one of a product and a service, and a third web page about contact information.

23. A computer readable media storing instructions to cause a computing device to:
provide a web based application server programmed to interact with a client device to gather business data, the business data including an industry sector;
send a first prompt for at least one of a product and a service to the client device, the first prompt being based on the industry sector;
receive data indicative of the at least one product and service from the client device;
retrieve a business graphic based on the industry sector;
receive a business graphic selection;
generate and sending a plurality of different styles to the client device, the plurality of different styles being based on the business graphic selection;
receive data indicative of a style selection from the client device;
produce a collateral print material based on the data indicative of the industry sector, the graphic selection, and the style selection;
select predetermined text based on the industry sector; and
produce a custom web site based on the data indicative of the industry sector, the graphic selection, and the style selection, the custom web site including text that is synthesized from (i) data received from the user and (ii) the predetermined text.

24. The computer readable media of claim 23, wherein the business data includes at least one of a name of the business, a geographic location of the business, and contact information of the business.

25. The computer readable media of claim 23, wherein the business data includes at least one of a structure of the business, a slogan of the business, a trademark of the business, a founding year of the business, a founder's name of the business, a client of the business, annual sales of the business, and a number of employees of the business.

26. The computer readable media of claim 23, further comprising:
sending a second prompt for at least one officer attribute to the client device; and
receiving data indicative of the at least one officer attribute from the client device.

27. The computer readable media of claim 26, wherein receiving data indicative of the officer attribute includes receiving data indicative of at least one of a name of a company officer, a previous employment of the company officer, a school attended by the company officer, and a professional association of the company officer, a diploma of the company officer, and a hobby of the company officer.

28. The computer readable media of claim 23, wherein receiving data indicative of the at least one service includes receiving data indicative of at least one of a service distinctive.

29. The computer readable media of claim 28, wherein the service distinctive includes at least one aspect of affordability, user centricness, geographic accessibility, convenience, timeliness, and quality.

30. The computer readable media of claim 23, wherein receiving data indicative of the at least one product includes receiving data indicative of at least one of a product label, a product identifier, a product description, a product price, and a product image.

31. The computer readable media of claim 23, wherein generating and sending the plurality of different styles to the client device includes generating and sending a plurality of different business cards styles to the client device.

32. The computer readable media of claim 23, wherein producing the collateral print material includes producing data indicative of at least one of a business card, an envelope, a letterhead, a check, and a sticker.

33. The computer readable media of claim 23, wherein producing the custom web site includes producing a first web page about a business, at least a second web page about at least one of a product and a service, and a third web page about contact information.
